(19) United States
(12) Patent Application Publication
(10) Pub. No.: US 2015/0131328 A1
(43) Pub. Date: May 14, 2015

(54) SYSTEM AND METHOD FOR POWER CONVERSION

(71) Applicant: General Electric Company, Schenectady, NY (US)

(72) Inventors: Fengfeng Tao, Clifton Park, NY (US); Michael Joseph Schutten, Rotterdam, NY (US); Eladio Clemente Delgado, Burnt Hills, NY (US); Luis Jose Garces, Niskayuna, NY (US); Rui Zhou, Niskayuna, NY (US); Xinhui Wu, Clifton park, NY (US); Maja Harfman Todorovic, Niskayuna, NY (US); Lei Wang, Austin, TX (US)

(73) Assignee: General Eectric Company, Schenectady, NY (US)

(21) Appl. No.: 14/074,778

(22) Filed: Nov. 8, 2013

(51) Int. Cl. H02M 3/335

(52) U.S. Cl. CPC H02M 3/33507
USPC 363/17

(57) ABSTRACT

A power conversion system is presented. The system includes a power source coupled to a power converter and a controller. The controller is configured to determine a value of at least one parameter corresponding to the power source. Additionally, the controller is configured to provide a first portion of the at least one parameter to the power converter and modify an operating frequency of the power converter, duty ratio of the power converter, or a combination thereof. Furthermore, the controller is configured to obtain an electrical quantity at an output of the power converter based on the modified operating frequency, the modified duty ratio, or a combination thereof. Also, the controller is configured to deliver a combination of the electrical quantity obtained at the output of the power converter and a second portion of the at least one parameter to a load. Method for converting power is also presented.

This invention was made with Government support under grant number DE-EE0005344 awarded by the Government. The Government has certain rights in the invention.

### BACKGROUND

Embodiments of the present disclosure generally relate to power conversion and more specifically to power conversion using a soft switched direct current to direct current power converter configured to process partial power.

Typically, a power conversion system includes a source operatively coupled to a power converter and a load. Also, a photovoltaic (PV) power conversion system includes a power source operatively coupled to a load via a direct current (DC) to DC power converter, a DC link, and a DC to alternating current (AC) power converter. Moreover, in the PV power conversion system, in order to maximize energy yield, a PV panel is operated at a maximum power point (MPP). However, values of output voltage, current, or power of the PV panel at the maximum power point may fail to meet the voltage and/or current requirements of the load.

Different control techniques and topologies of power conversion systems have been developed to provide desired values of voltage, current, or power to the load. In conventional topologies of the power conversion system, the DC to DC power converter is required to process the full power generated across the PV panel. However, this processing results in increased losses in the power conversion system. Furthermore, these DC to DC converters use high power rating switches thereby increasing the cost and size of the power conversion system.

Moreover, in general, the switches used in the DC to DC power converters employ a hard switching mechanism. The hard switching mechanism is known to result in high switching losses in the power conversion system.

### BRIEF DESCRIPTION

In accordance with aspects of the present disclosure, a power conversion system is presented. The system includes a power source. Also, the system includes a power converter operatively coupled to the power source. Moreover, the system includes a controller configured to determine a value of at least one parameter corresponding to the power source. Additionally, the controller is configured to provide a first portion of the at least one parameter to the power converter and modify an operating frequency of the power converter, duty ratio of the power converter, or a combination thereof. Furthermore, the controller is configured to obtain an electrical quantity at an output of the power converter based on the modified operating frequency, the modified duty ratio, or a combination thereof. In addition, the controller is configured to deliver a combination of the electrical quantity obtained at the output of the power converter and a second portion of the at least one parameter to a load.

In accordance with another aspect of the present disclosure, a method for converting power is presented. The method includes coupling a power source to a power converter and a load. Further, the method includes determining a value of at least one parameter corresponding to the power source. Also, the method includes providing a first portion of the at least one parameter to the power converter. In addition, the method includes modifying an operating frequency of the power converter, a duty ratio of the power converter, or a combination thereof. Additionally, the method includes obtaining an electrical quantity at an output of the power converter based on the modified operating frequency, the modified duty ratio, or a combination thereof. The method also includes delivering a combination of the electrical quantity obtained at the output of the power converter and a second portion of the at least one parameter to the load.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of an exemplary power conversion system, according to aspects of the present disclosure;

FIG. 2 is a diagrammatical representation of an exemplary embodiment of the power conversion system of FIG. 1, according to aspects of the present disclosure;

FIG. 3 is a diagrammatical representation of waveforms generated by the exemplary power conversion system of FIG. 2, according to aspects of the present disclosure;

FIGS. 4-7 are diagrammatical representations of different embodiments of a resonant circuit for use in the exemplary power conversion system of FIG. 1, according to aspects of the present disclosure;

FIGS. 8-9 are diagrammatical representations of a portion of a power conversion system of FIG. 1, according to aspects of the present disclosure;

FIG. 10 is a diagrammatical representation of another exemplary embodiment of the power conversion system of FIG. 1, according to aspects of the present disclosure;

FIG. 11 is a diagrammatical representation of yet another exemplary embodiment of the power conversion system of FIG. 1, according to aspects of the present disclosure;

FIG. 12 is a diagrammatical representation of an electrical characteristic of a photovoltaic panel; and

FIG. 13 is a flow chart representing an exemplary method for power conversion, according to aspects of the present disclosure.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit” and “circuitry” and “controller” may include either a single component or a plurality of components, which are either active and/or passive and are connected or otherwise coupled together to provide the described function.

As will be described in detail hereinafter, various embodiments of an exemplary system and method for power conversion are presented. By employing the system and the method for power conversion described hereinafter, a soft switched DC to DC partial power converter is provided. The term partial power converter, as used herein, is used to refer to a converter configured to process a determined portion of power fed from a power source.

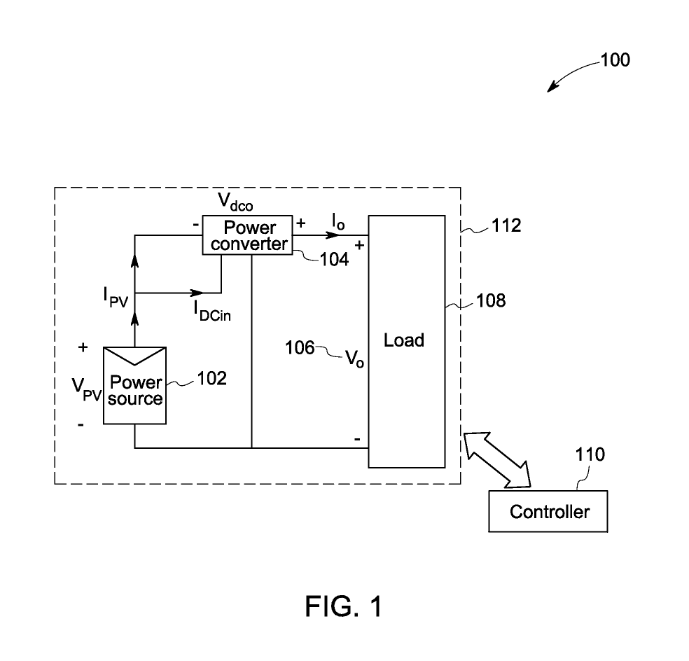

Turning now to the drawings, by way of example in FIG. 1, a power conversion system 100 is depicted. In one embodiment, the power conversion system 100 may include a power source 102 operatively coupled to a power converter 104. In addition, an input of the power converter 104 may be operatively coupled in parallel with the power source 102, while an output of the power converter 104 may be operatively coupled in series with the power source 102. The power converter 104 may include a series parallel resonant converter or a LLC resonant converter. It may be noted that the LLC resonant converter exhibits high partial load efficiency. Hence, when the LLC resonant converter is employed as the power converter 104 and partial power is provided to the power converter 104, improved power conversion efficiency may be achieved.

The term power source, as used herein, may be used to refer to a renewable power source, a non-renewable power source, a generator, a grid, a fuel cell, a battery, and the like. In a presently contemplated configuration, the power source 102 may include a photovoltaic (PV) panel. Also, the power converter 104 may be operatively coupled to a load 108. In one non-limiting example, the load 108 may include a DC link, a DC to AC converter, a grid, an electrical appliance, a motor, or combinations thereof. The voltage across the load 108 may be represented as Vₒ, in the example of FIG. 1. Additionally, the voltage Vₒ may be represented by reference numeral 106. For the ease of representation, the power source 102, the power converter 104, and the load 108 are depicted as a single unit, and represented by reference numeral 112.

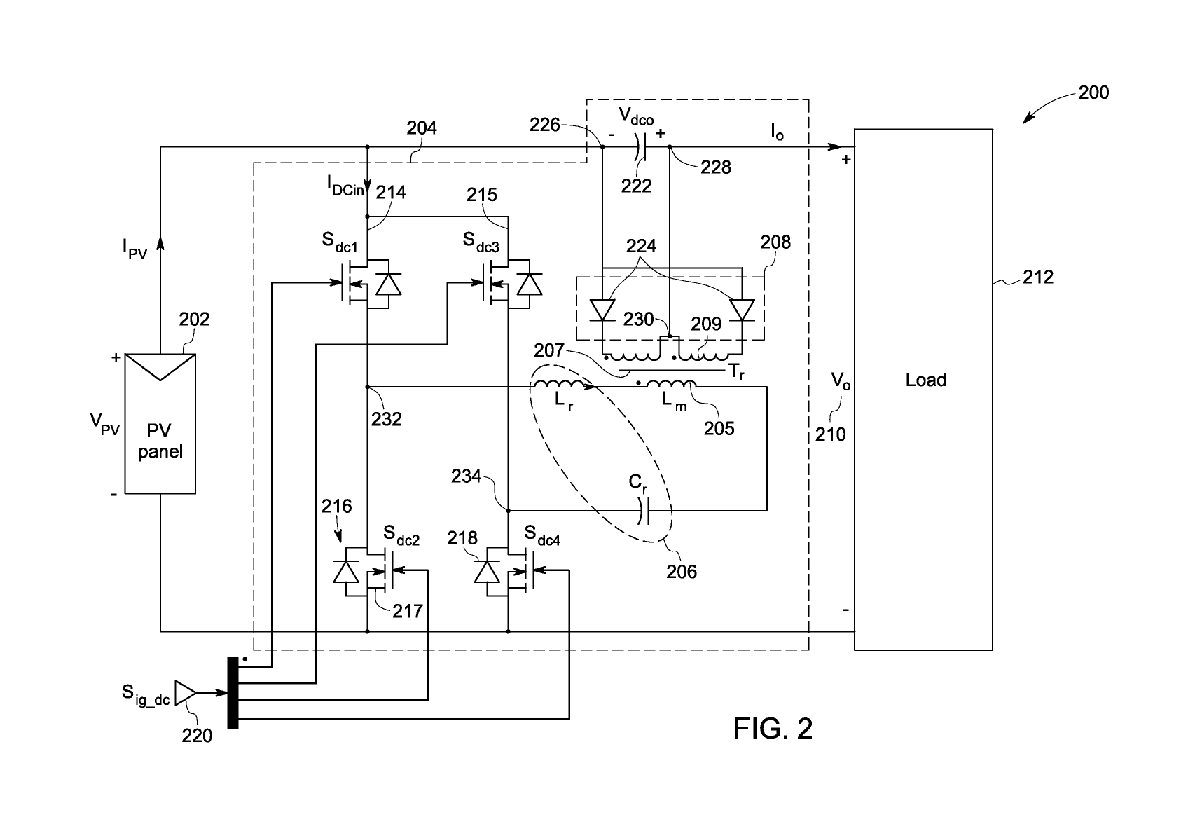

Moreover, in a presently contemplated configuration, the power converter 104 may include at least one phase leg, a resonant circuit, a transformer, a rectifier, or combinations thereof. The phase leg may in turn include at least two semiconductor switches. The semiconductor switches may include an insulated gate bipolar transistor (IGBT), a metal oxide semiconductor field effect transistor (MOSFET), a field effect transistor (FET), an injection enhanced gate transistor, an integrated gate commutated thyristor, a diode, or combinations thereof. In one embodiment, the at least two semiconductor switches may include a gallium arsenide based switch, a gallium nitride based switch, a silicon carbide based switch, or combinations thereof. The topology of the power converter 104 will be explained in greater detail with reference to FIG. 2.

Further, the system 100 may include a controller 110. In the example of FIG. 1, the controller 110 is shown as being operatively coupled to the unit 112. However, in other examples, the controller 110 may be operatively coupled to one or more of the power source 102, the power converter 104, and the load 108. Moreover, the term ‘operatively coupled,’ as used herein, may be used to refer to wired coupling, electrical coupling, and the like. In one example, the controller 110 may be disposed at a remote location.

The controller 110 may be configured to determine a value of at least one parameter corresponding to the power source 102. The term ‘at least one parameter,’ as used herein, may refer to a voltage, a current, a power, or a combination thereof corresponding to the power source 102. Furthermore, the controller 110 may be configured to provide a first portion of the at least one parameter corresponding to the power source 102 to the power converter 104. The term ‘first portion,’ as used herein, may be used to refer to a determined portion of the at least one parameter corresponding to the power source 102. The remaining portion (excluding the determined portion) of the at least one parameter may generally be referred to as a ‘second portion’ of the at least one parameter. Accordingly, the sum total of the first and second portions of the at least one parameter may provide a total value of the at least one parameter corresponding to the power source 102.

In one example, the first portion of the at least one parameter may include a determined portion of total power generated by the power source 102. This determined portion of total power may be provided to the power converter 104, in one example. Therefore, only partial power may be provided to the power converter 104 instead of the total power generated by the power source 102. In one non-limiting example, the second portion of the total power may include a remaining portion (excluding the determined portion) of the total power generated by the power source 102. Furthermore, in one example, the determined portion of the total power may be a ratio of voltage at an input of the power converter 104 and voltage at an output of the power converter 104. Also, the determined portion of the total power may be dependent on the type of PV cell employed in a PV panel, configuration of the power converter 104, a voltage at the load 108, and the like. In one non-limiting example, the determined portion of the total power may be in a range from about 5% to about 35% of the total power. Although the present example provides the range for the determined portion of the total power from about 5% to about 35%, other ranges for the determined portion of the total power may also be envisaged.

Additionally, the controller 110 may be configured to selectively switch the at least two semiconductor switches of the power converter 104. The selective switching of the semiconductor switches may include an activation and deactivation of the semiconductor switches. In accordance with aspects of the present disclosure, the at least two semiconductor switches may be switched based on a switching pattern determined by the controller 110. This switching of the semiconductor switches may be regulated by the controller 110. Furthermore, the controller 110 may aid in determining an operating frequency and/or a duty ratio of the power converter 104. Moreover, the controller 110 may be configured to modify the operating frequency and/or the duty ratio of the power converter 104. In one embodiment, the operating frequency and/or the duty ratio of the power converter 104 may be modified by varying the switching pattern of the semiconductor switches.

Also, an input voltage into a resonant circuit of the power converter 104 may be modified by adjusting the duty ratio of the power converter 104. In one example, the input voltage into the resonant circuit of the power converter 104 may be modified by adjusting a duty ratio of the phase leg of the power converter 104 and/or a phase shift between the phase legs of the power converter 104. The modification of the input voltage into the resonant circuit of the power converter 104 and the duty ratio of the power converter will be explained in greater detail with respect to FIG. 2. Also, it may be noted that voltage gain of the power converter 104 is a function of the operating frequency of the power converter 104. Hence, any variation in the operating frequency of the power converter 104 may in turn cause a voltage gain of the power converter 104 to vary. The controller 110 may also be configured to determine an electrical quantity at an output of the power converter 104 corresponding to the modified operating frequency of the power converter 104 and/or the modified input voltage into the resonant circuit of the power converter 104. The term ‘electrical quantity,’ as used herein, may be used to refer to a voltage, a current, or a combination thereof.

Moreover, the controller 110 may also be configured to cause a switch current to flow through the semiconductor switches of the power converter 104 when a voltage across the at least two semiconductor switches has a substantially low value. In one non-limiting example, the controller 110 may be configured to cause the switch current to flow through the semiconductor switches when the value of voltage across the semiconductor switches is zero. Also, the semiconductor switches of the power converter 104 may be activated when the voltage across the corresponding semiconductor switch is zero. This activation of the semiconductor switch when voltage across the semiconductor switch is zero may be referred to as zero voltage soft switching.

Furthermore, the controller 110 may be configured to control the value of the at least one parameter corresponding to the power source 102 to achieve a maximum power output from the power source 102. In one non-limiting example, a voltage or a current of the PV panel may be regulated to obtain a maximum power output from the PV panel. Additionally, the controller 110 may be configured to track the maximum power output from the PV panel.

Moreover, it may be noted that the voltage across the load 108 may vary with a variation in demand for power from the load 108. Particularly, the voltage across the load 108 may vary with a variation in the demand for power from the grid component of the load 108. As will be appreciated, power is a product of voltage and current. Accordingly, the variation in demand for power from the load 108 may result in a variation in the voltage to be supplied to the load 108. In accordance with aspects of present disclosure, the controller 110 may be configured to modify an output voltage of the power converter 104 and the output of the PV panel 102 to provide a desired voltage to the load 108. In one non-limiting example, the controller 110 may be configured to provide a combination of the voltage determined at the output of the power converter 104 and the voltage corresponding to the power source 102 to the load 108. The term ‘combination’ as used herein, may be used to refer to a sum total of the voltage determined at the output of the power converter 104 and the voltage corresponding to the power source 102.

Referring to FIG. 2, a diagrammatical representation 200 of an exemplary embodiment of the power conversion system 100 of FIG. 1, according to aspects of the present disclosure, is depicted. The system 200 may include a power source 202. In the example of FIG. 2, the power source 202 may include a PV panel. The voltage at the PV panel 202 may be represented as V_{PV} and a current generated by the PV panel may be represented as I_{PV}. Furthermore, the system 200 may include a power converter 204 operatively coupled to the PV panel. Also, the power converter 204 may be coupled to a load 212. The load 212 may include a DC link, a DC to AC power converter, a grid, or combinations thereof. A current I_{DCin} may be provided to the power converter 204. Also, the current provided to the load 212 may be represented as Iₒ. Furthermore, a voltage Vₒ across the load 212 may be represented by reference numeral 210.

In the example of FIG. 2, the power converter 204 may include two phase legs 214, 215. The phase legs 214, 215 may each include two semiconductor switches 216. The semiconductor switches 216 corresponding to the two phase legs 214, 215 may be represented as S_{dc1}, S_{dc2}, S_{dc3}, and S_{dc4}. Also, each semiconductor switch 216 may include a MOSFET 217 with a parasitic body diode. In one example, the semiconductor switch 216 may include the MOSFET 217 and a discrete antiparallel diode 218. The diode 218 may provide an alternate path for the flow of current through the semiconductor switch 216. Additionally, the system 200 may include a gating signal unit 220 configured to selectively provide a gating signal to the semiconductor switches 216 (S_{dc1}, S_{dc2}, S_{dc3}, and S_{dc4}). Accordingly, the semiconductor switches 216 (S_{dc1}, S_{dc2}, S_{dc3}, and S_{dc4}) may be selectively switched using the gating signal. As noted hereinabove, the selective switching of the semiconductor switches may include an activation and deactivation of the semiconductor switches. In one non-limiting example, the gating signal unit 220 may be regulated by a controller, such as the controller 110 of FIG. 1.

Additionally, the four semiconductor switches 216 may be switched based on a switching pattern determined by the controller. In one example, the semiconductor switch S_{dc4} may be switched at a phase shift of 180 degrees with respect to the semiconductor switch S_{dc1}. In another non-limiting example, the semiconductor switches S_{dc1} and S_{dc4} may be switched at substantially similar frequencies.

As previously noted, each of the phase legs 214, 215 may include two semiconductor switches 216. In one embodiment, the phase leg 214 includes two semiconductor switches S_{dc1} and S_{dc2}, while the phase leg 215 includes two semiconductor switches S_{dc3} and S_{dc4} By way of example, the two semiconductor switches S_{dc1} and S_{dc2} in the phase leg 214 may be configured as a totem pole half bridge. Moreover, the two semiconductor switches S_{dc3} and S_{dc4} in the phase leg 215 may also be configured as a totem pole half bridge. In one example, a duty ratio of the phase leg 214 may be a ratio of the time during which the switch S_{dc1} is in an activated condition to a total time period. The total time period may include a sum of a period during which the semiconductor switch S_{dc1} is in the activated condition and a period during which the semiconductor switch S_{dc1} is in a deactivated condition. The semiconductor switch S_{dc2} operates in a complementary fashion with respect to the semiconductor switch S_{dc1}.

Furthermore, in one embodiment, the power converter 204 may include a resonant circuit 206, a transformer 207, and a rectifier 208 operatively coupled to each of the phase legs 214, 215. In one example, the rectifier 208 may include an ordinary rectifier, a synchronous rectifier, or a combination thereof. As will be appreciated, the ordinary rectifier includes semiconductor diodes, while in the synchronous rectifier the semiconductor diodes are replaced by controlled semiconductor switches, such as, but not limited to, MOSFET, transistor, FET, and IGBT. The resonant circuit 206 may include an inductor represented as Lᵣ and a capacitor represented as Cᵣ. Moreover, the resonant circuit 206 may be operatively coupled to the rectifier 208 via the transformer 207. In one embodiment, the resonant circuit 206 may be operatively coupled to a primary winding 205 of the transformer 207. The magnetizing inductance of the transformer 207 may be represented as Lₘ. In one example, the magnetizing inductance Lₘ of the transformer 207 may form a part of the resonant circuit 206. Also, the transformer 207 may include at least one primary winding, at least one secondary winding, or a combination thereof, in one non-limiting example. Moreover, the resonant circuit 206 may be operatively coupled to the phase leg 214 at a first terminal 232 and the phase leg 215 at a second terminal 234. Also, an input voltage to the resonant circuit 206 may appear across the first terminal 232 and the second terminal 234.

In the example of FIG. 2, the rectifier 208 may include two semiconductor diodes 224. Moreover, cathode terminals of both the semiconductor diodes 224 of the rectifier 208 may be operatively coupled to either ends of a secondary winding 209 of the transformer 207. Furthermore, anode terminals of both the semiconductor diodes 224 may be operatively coupled to a first node 226. Also, a center tap 230 of the secondary winding 209 of the transformer 207 may be operatively coupled to a second node 228. In one non-limiting example, the secondary winding 209 of the transformer 207 may include two windings on either sides of the center tap 230.

Furthermore, in one example, a capacitor 222 may be operatively coupled between the first node 226 and the second node 228. The rectifier 208 may be configured to provide a DC voltage across the capacitor 222. In one example, an output voltage of the power converter 204 may be obtained across the capacitor 222. The output voltage of the power converter 204 may be represented as V_{dco}. In addition, in the example of FIG. 2, the voltage across the load Vₒ may be equivalent to a sum of the voltage across the PV panel 202 V_{PV} and the voltage across the capacitor 222 V_{dco}. Although the example of FIG. 2 includes the capacitor 222, a power converter configuration devoid of the capacitor 222 may also be envisaged.

Moreover, in accordance with aspects of the present disclosure, the output voltage of the power converter 204 V_{dco} may be adjusted such that the PV panel 202 is operated to generate a maximum power for a given output voltage of the power converter 204. The maximum power may be generated from the PV panel 202 by operating the PV panel 202 at a maximum power point (MPP). Also, in one example, value of the output voltage of the power converter 204 may be determined based on the demand for power from the load 212 and the power output of the PV panel 202. In one non-limiting example, sum of voltage across the PV panel 202 V_{PV} and the output voltage of the power converter 204 V_{dco} may be equivalent to the voltage across the load Vₒ.

As noted hereinabove, an operating frequency and/or duty ratio of the power converter 204 may be modified. In one embodiment, the operating frequency and/or duty ratio of the power converter 204 may be modified by varying the switching pattern of the semiconductor switches 216. By way of example, based on a given switching pattern, the semiconductor switches of the power converter 204 may be switched such that a desired operating frequency and/or duty ratio of the power converter 204 may be achieved. In particular, the desired duty ratio of the power converter 204 may be achieved by employing a phase shift control, a duty cycle control, or a combination thereof. More particularly, the input voltage into the resonant circuit 206 of the power converter 204 may be modified by adjusting the duty ratio of the phase legs 214, 215 of the power converter 204. In another example, the input voltage into the resonant circuit 206 of the power converter 104 may be modified by adjusting a phase shift between the phase legs 214, 215. The term phase shift, as used herein, may be used to refer to a phase shift between the switching of the switches of the phase leg 214 and the phase leg 215.

It may be noted that the voltage gain of the power converter 204 is a function of the operating frequency. Accordingly, modifying the operating frequency of the power converter 204 may lead to a change in the voltage gain of the power converter 204. The change in the voltage gain of the power converter 204 and/or the input voltage to the resonant circuit 206 may in turn adjust the output voltage V_{dco} of the power converter 204.

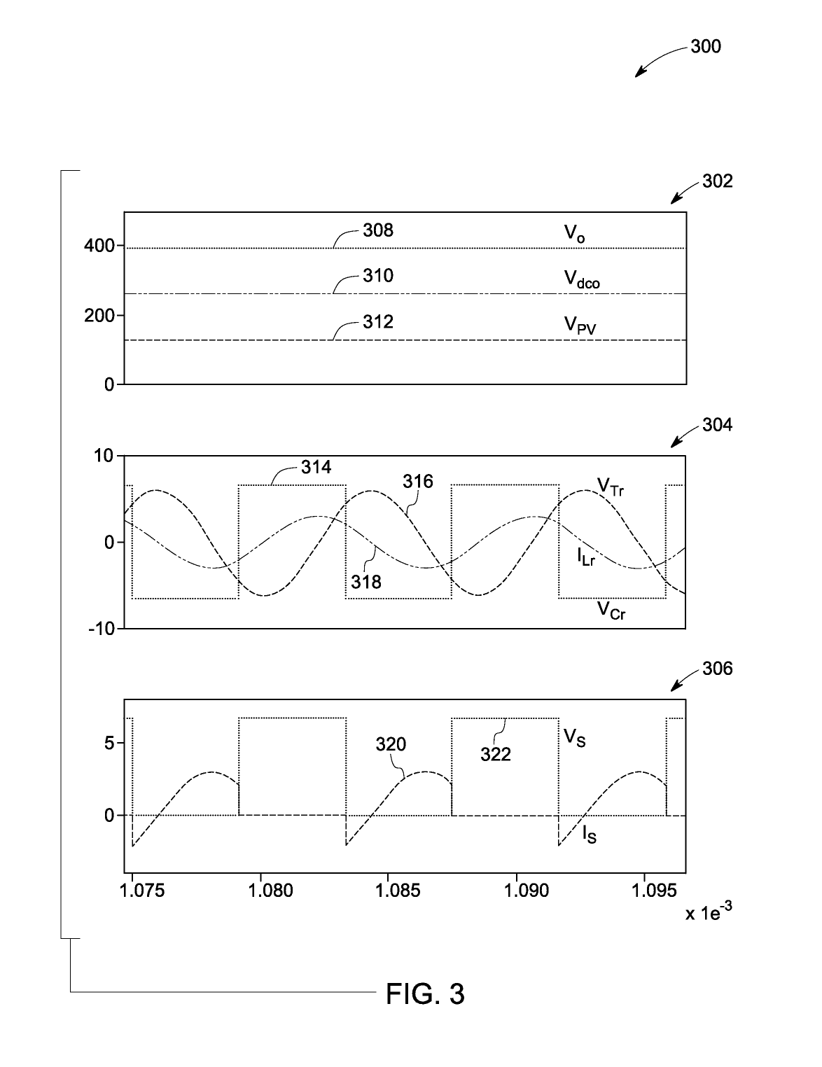

Turning now to FIG. 3, a diagrammatical representation 300 of a first set of waveforms generated in the exemplary power conversion system 200 of FIG. 2, according to aspects of the present disclosure, is depicted. Reference numeral 302 represents voltage waveforms. In particular, reference numeral 308 represents a voltage across the load 212 (Vₒ), while reference numeral 310 represents an output voltage of the power converter 204 (V_{dc0}). Also, reference numeral 312 represents a voltage across the PV panel 202 (V_{PV}). The voltage 308 across the load Vₒ is a sum of the output voltage 310 of the power converter 204 V_{dco} and the voltage 312 across the PV panel 202 (V_{PV}). In one example, the output voltage of the power converter 204 may include a DC voltage.

Reference numeral 304 is a diagrammatical representation of a second set of waveforms generated in the exemplary power conversion system 200 of FIG. 2. A voltage across the capacitor Cᵣ (V_{Cr}) is represented by reference numeral 316. Furthermore, a current through the inductor Lᵣ, (I_{Lr}) is represented by reference numeral 318. Moreover, a voltage across the transformer Tᵣ (V_{Tr}) is represented by reference numeral 314. It may be noted that the voltage at the transformer V_{Tr} is an AC voltage.

In addition, reference numeral 306 is a diagrammatical representation of a third set of waveforms generated in the exemplary power conversion system 200 of FIG. 2. A voltage across the semiconductor switch Vₛ, such as the semiconductor switch 216 of FIG. 2, may be represented by reference numeral 322. A current Iₛ through the semiconductor switch 216 may be represented by reference numeral 320. In the example of FIG. 3, the current Iₛ flows through the semiconductor switch 216 when the voltage Vₛ across the semiconductor switch 216 is zero. Accordingly, the semiconductor switch 216 may be activated when the voltage Vₛ across the semiconductor switch is zero. This activation of the semiconductor switch when the voltage Vₛ is zero may be referred to as zero voltage soft switching. Since the current Iₛ flows through the semiconductor switch 216 when the voltage across the semiconductor switch Vₛ is substantially low, the power loss in the semiconductor switch 216 at any instant of time may be substantially low or zero.

As noted hereinabove, in one example, the semiconductor switch 216 may include the MOSFET 217. As will be appreciated, the MOSFET may include a body, a drain, a source, and a gate terminal. It may be noted that a conducting channel is formed between the drain and source terminals of the MOSFET. Also, a parasitic capacitor may exist between the drain and source terminals of the MOSFET. In one example, the parasitic capacitor may provide an alternate path for the current passing through the MOSFET. When the MOSFET 217 is activated, the current through the semiconductor switch 216 is shifted from the conducting channel to the parasitic capacitor of the MOSFET 217. This shift of the current to the parasitic capacitor causes a reduction in overlap of the voltage and current within the MOSFET 217 resulting in reduced switching losses. This reduction in the overlap of the voltage and current may in turn lead to a reduction in the power loss.

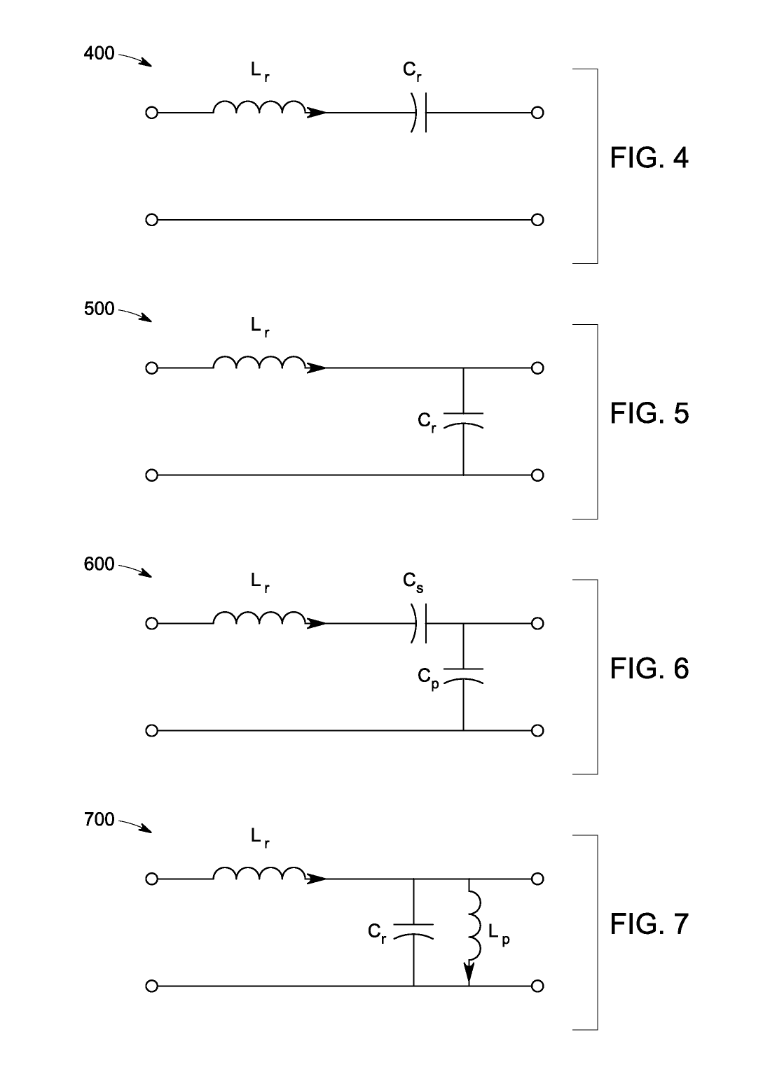

FIGS. 4-7 are diagrammatical representations 400, 500, 600, 700 of different embodiments of a resonant circuit, such as the resonant circuit 206, for use in the exemplary power conversion system 100 of FIG. 1. FIG. 4 is a diagrammatical representation 400 of an embodiment of a resonant circuit, where the resonant circuit 400 may include an inductor Lᵣ and a capacitor Cᵣ arranged in a series configuration. In the embodiment of FIG. 5, the resonant circuit 500 may include an inductor Lᵣ arranged in parallel with a capacitor Cᵣ. Moreover, FIG. 6 is a diagrammatical representation 600 of yet another embodiment of a resonant circuit, where the resonant circuit 600 may include an inductor Lᵣ in series with a capacitor Cₛ. Further, the series combination of Lᵣ and Cₛ may be operatively coupled in parallel to a capacitor Cₚ. Additionally, in the example of FIG. 7 the resonant circuit 700 may include an inductor Lᵣ operatively coupled in parallel to a parallel combination of a capacitor Cᵣ and inductor Lₚ.

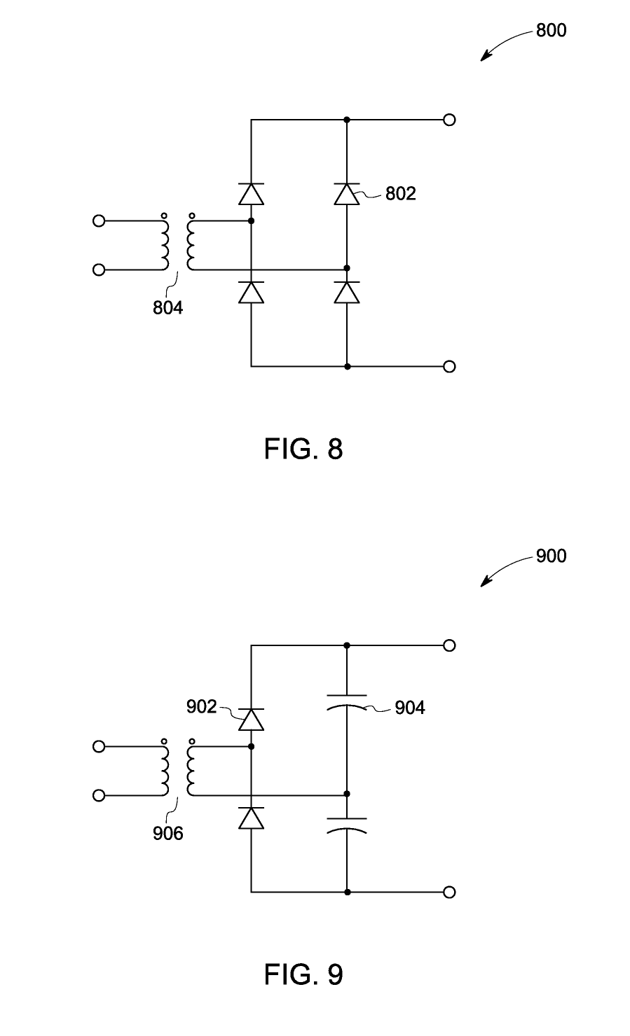

Referring now to FIGS. 8-9, diagrammatical representations of different embodiments of a portion of the exemplary power conversion system 100 of FIG. 1, according to the aspects of the present disclosure, are depicted. FIG. 8 is a diagrammatical representation 800 of a full bridge rectifier including four semiconductor switches 802. The full bridge rectifier 800 may be operatively coupled to a transformer 804. In the example of FIG. 8, the semiconductor switches 802 may include a semiconductor diode, a controlled semiconductor switch, or a combination thereof. The controlled semiconductor switch may include a MOSFET, a FET, a transistor, an IGBT, and the like, in one example.

Additionally, FIG. 9 is a diagrammatical representation 900 of a rectifier including two semiconductor switches 902 and two capacitors 904. A leg including the two semiconductor switches 902 may be operatively coupled in parallel to a leg including the two capacitors 904. Furthermore, the rectifier 900 may be operatively coupled to a transformer 906. In the example of FIG. 9, the semiconductor switches 902 may include a semiconductor diode, a controlled semiconductor switch, or a combination thereof.

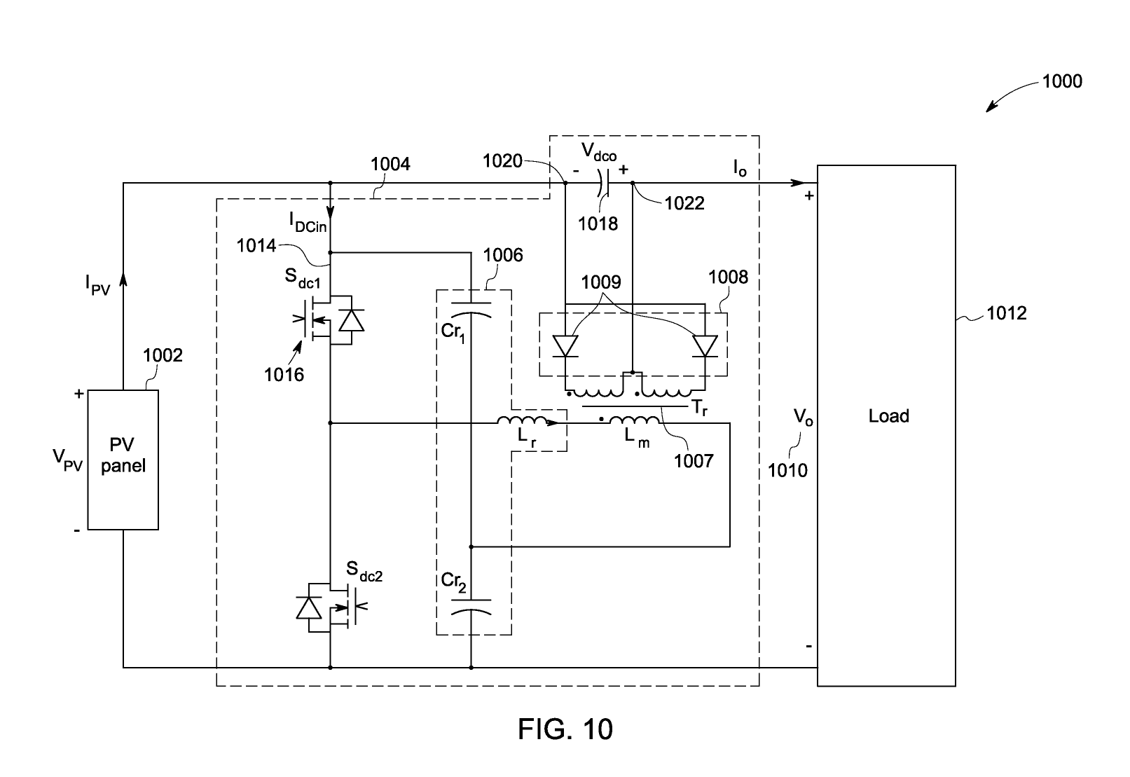

Turning now to FIG. 10, a diagrammatical representation 1000 of another exemplary embodiment of the power conversion system 100 of FIG. 1, according to aspects of the present disclosure, is depicted. The system 1000 may include a power source 1002. In a presently contemplated configuration, the power source 1002 may include a PV panel. The PV panel 1002 may be operatively coupled to a power converter 1004 and a load 1012. As previously noted, the load 1012 may include a DC link, a DC to AC power converter, a grid, or combinations thereof. A voltage across the load Vₒ may be represented by reference numeral 1010.

In the example of FIG. 10, the power converter 1004 may include a phase leg 1014, a resonant circuit 1006, a transformer 1007, and a rectifier 1008. The phase leg 1014 may include two semiconductor switches 1016. Also, the power converter 1004 may include a half bridge circuit. In a presently contemplated configuration, the semiconductor switches 1016 may include a MOSFET operatively coupled to a diode. The resonant circuit 1006 may include at least two capacitors Cᵣ₁, Cᵣ₂ and an inductor Lᵣ. Furthermore, the inductor Lᵣ of the resonant circuit 1006 may be operatively coupled to a primary winding of the transformer 1007.

Also, the rectifier 1008 may include two semiconductor diodes 1009. Cathode terminals of both the semiconductor diodes 1009 may be operatively coupled to either end of a secondary winding of the transformer 1007. Furthermore, anode terminals of both the semiconductor diodes 1009 may be operatively coupled to a terminal 1020. A center tap of the secondary winding of the transformer 1007 may be operatively coupled to a terminal 1022. In the example of FIG. 10, the secondary winding of the transformer 1007 may include two windings.

Additionally, the output of the power converter 1004 may be obtained across a capacitor 1018, in one embodiment. Moreover, the capacitor 1018 may be operatively coupled between terminals 1020, 1022. Although in the example of FIG. 10, the output of the power converter 1004 is obtained across the capacitor 1018, a power converter configuration devoid of the capacitor 1018 may be envisaged.

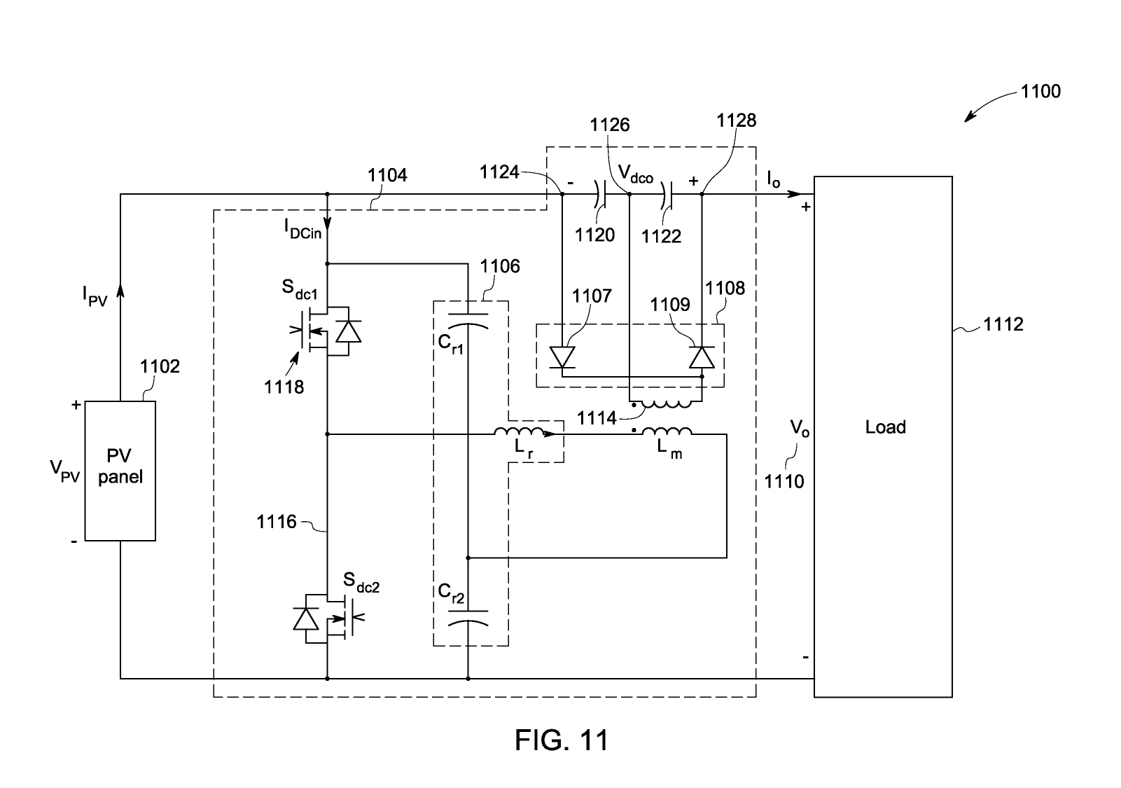

Referring now to FIG. 11, a diagrammatical representation 1100 of another exemplary embodiment of the power conversion system 100 of FIG. 1, according to aspects of the present disclosure, is depicted. The system 1100 may include a power source 1102. In the example of FIG. 11, the power source 1102 may include a PV panel. Furthermore, the PV panel 1102 may be operatively coupled to a power converter 1104. The power converter 1104 may be operatively coupled to a load 1112. Reference numeral 1110 represents a voltage across the load (Vₒ). The power converter 1104 may include a phase leg 1116 having two semiconductor switches 1118. Moreover, the power converter 1104 may include a resonant circuit 1106. The resonant circuit 1106 may include an inductor Lᵣ and two capacitors Cᵣ₁ and Cᵣ₂.

The power converter 1104 may also include a transformer 1114, represented as Tᵣ and having a magnetizing inductance Lₘ. Furthermore, a primary winding of the transformer 1114 may be coupled to the inductor Lᵣ of the resonant circuit 1106. A secondary winding of the transformer 1114 may be operatively coupled to a rectifier 1108. The rectifier 1108 may include two semiconductor diodes 1107 and 1109. Also, the rectifier 1108 may be operatively coupled to two capacitors 1120, 1122. In one embodiment, the capacitor 1120 may be operatively coupled between a first node 1124 and a second node 1126. Furthermore, the capacitor 1122 may be operatively coupled between the second node 1126 and a third node 1128. The output V_{dco} of the power converter 1104 may be obtained across the capacitors 1120, 1122.

The anode of the semiconductor diode 1109 may be operatively coupled to the cathode of the semiconductor diode 1107. In addition, the anode of the semiconductor diode 1109 may be operatively coupled to one end of the secondary winding of the transformer 1114. Moreover, the cathode of the diode 1109 may be operatively coupled to the third node 1128. In addition, the anode of the diode 1107 may be operatively coupled to the first node 1124. It may be noted that in FIG. 11, the secondary winding of the transformer 1114 may include only a single winding. Also, in the examples of FIGS. 10 and 11, the power converter may include only two semiconductor switches, thereby causing a reduction in switching losses and cost of the power converter.

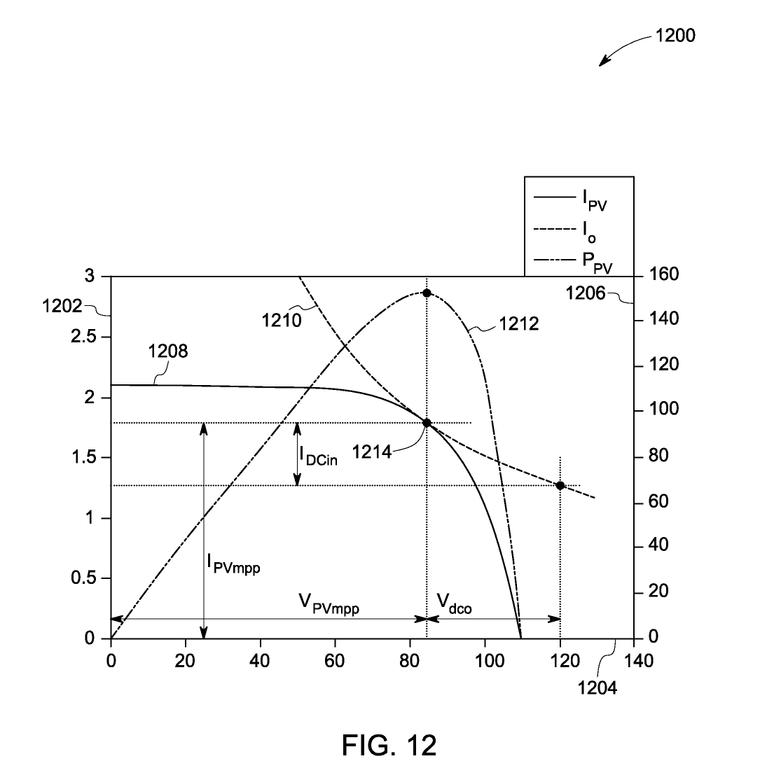

FIG. 12 is a diagrammatical representation 1200 of an electrical characteristic of a PV panel configured for use in the power conversion system 100 of FIG. 1. Reference numeral 1202 represents a value of current in a PV panel, such as the PV panel 202 of FIG. 2. Also, axis 1204 represents a value of voltage of the PV panel. Furthermore, reference numeral 1206 represents a value of power of the PV panel.

Moreover, curve 1208 represents a current characteristic of the PV panel. Also, curve 1210 represents a characteristic of a current fed to the load, such as the load 212 of FIG. 2. Curve 1212 represents a characteristic of an output power of the PV panel. Reference numeral 1214 represents a maximum power point (MPP) of the PV panel. During operation of the PV panel at the maximum power point, the current output of the PV panel may be represented as I_{PVmpp}, while the voltage across the PV panel at maximum power point may be represented as V_{PVmpp}. It may be noted that beyond the MPP 1214, the value of current in the PV panel and a value of current fed to the load drops in amplitude with increase in the value of voltage.

In accordance with exemplary aspects of the present disclosure, at the maximum power point of the PV panel, a determined portion of the current I_{PVmpp} may be supplied to the power converter, such as the power converter 204 of FIG. 2. The determined portion of the current may generally be represented as I_{DCin}. As noted hereinabove, power is a product of voltage and current. Accordingly, since only the determined portion of the current I_{PVmpp} is supplied to the power converter 204, there is a proportionate reduction in the amount of power supplied to the power converter 204. Therefore, instead of having to process a larger value of power, the exemplary power converter 204 may process a reduced value of power.

Furthermore, a sum of the voltage across the PV panel and voltage output of the power converter may be fed to the load. In one example, during the maximum power point operating condition, a sum of the voltage across the PV panel V_{PVmpp} and the voltage output of the power converter V_{dco} may be provided to the load. In certain load conditions, the voltage across the PV panel during the maximum power point condition (V_{PVmpp}) may not be sufficient to supply the voltage across the load. In accordance with aspects of present disclosure, this shortfall may be overcome by adjusting a voltage gain of the power converter. In one example, the voltage gain of the power converter may be adjusted by modifying the operating frequency of the power converter. Also, input voltage to the resonant circuit of the power converter may be adjusted by modifying the duty ratio. As noted hereinabove, the voltage gain of the power converter is a function of the operating frequency of the power converter 204. The power converter is configured to process the partial power provided from the PV panel to generate a voltage at the output of power converter based on the modified operating frequency and/or duty ratio of the power converter 204.

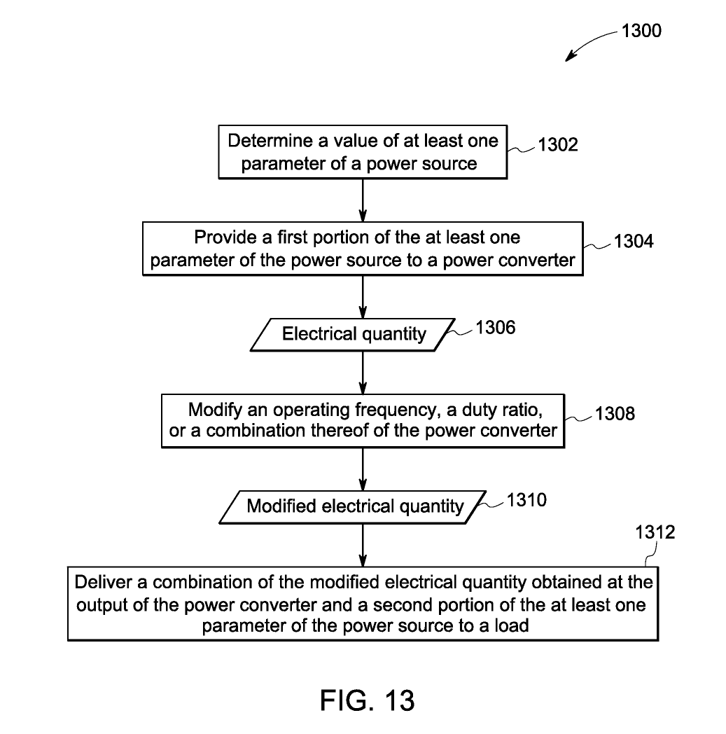

Turning now to FIG. 13, a flow chart 1300 representing an exemplary method for power conversion, according to aspects of the present disclosure, is represented. For the ease of understanding, the method of FIG. 13 will be described with respect to the elements of FIG. 2. The method begins at step 1302, where a value of at least one parameter corresponding to the power source 202 may be determined. The at least one parameter may include a voltage, a current, a power, or combinations thereof. In one embodiment, a value of current provided by the power source 202, such as, but not limited to, a PV panel may be determined.

Additionally, at step 1304, a first portion of the at least one parameter corresponding to the power source 202 may be provided to the power converter 204. In one non-limiting example, a first portion of the power generated by the PV panel 202 may be provided to the power converter 204. Consequent to processing by the power converter 204, an electrical quantity 1306 may be generated at an output of the power converter 204. The at least one parameter provided from the power source 202 may be processed by the power converter 204 to generate the electrical quantity 1306 at the output of the power converter 204. It may be noted that in one non-limiting example, the electrical quantity 1306 may include an output voltage of the power converter 204. Advantageously, the power converter 204 may need to process only a portion of the total power generated by the PV panel 202, thereby reducing losses in the power converter 204.

Also, at step 1308, an operating frequency and/or duty ratio of the power converter 204 may be modified. As noted hereinabove, the operating frequency and/or duty ratio of the power converter 204 may be modified by varying the switching patterns of the semiconductor switches 216. As a consequence of modifying the operating frequency of the power converter 204, a voltage gain of the power converter 204 may be varied. Moreover, as a result of change in the duty ratio of the power converter 204, the input voltage to the resonant circuit 206 may be varied. As previously noted, the voltage gain of the power converter 204 is a function of the operating frequency. Also, the input voltage to the resonant circuit 206 is a function of the duty ratio of the power converter. Based on the variation of the voltage gain of the power converter 204 and/or the input voltage to the resonant circuit 206 of the power converter 204, the electrical quantity 1306 may be modified. More particularly, consequent to the processing at step 1308 a modified electrical quantity 1310 may be generated.

Also, at step 1312, a combination of the modified electrical quantity 1310 generated at the output of the power converter 204 and a second portion of the at least one parameter corresponding to the power source 202 may be delivered to the load. In one example, a sum of the voltage generated at the PV panel 202 at maximum power point V_{PVmpp} and the voltage generated at the output of the power converter 204 (V_{dco}) may be provided to the load 212. Particularly, a sum of the power output from the power converter 204 and the second portion of the power generated by the PV panel may be provided to the load 212.

Furthermore, the foregoing examples, demonstrations, and process steps such as those that may be performed by the system may be implemented by suitable code on a processor-based system, such as a general-purpose or special-purpose computer. It should also be noted that different implementations of the present disclosure may perform some or all of the steps described herein in different orders or substantially concurrently, that is, in parallel. Furthermore, the functions may be implemented in a variety of programming languages, including but not limited to C, C++ or Java. Such code may be stored or adapted for storage on one or more tangible, machine readable media, such as on data repository chips, local or remote hard disks, optical disks (that is, CDs or DVDs), memory or other media, which may be accessed by a processor-based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

The various embodiments of the system and the method for converting power described hereinabove aid in developing a power converter configured to process partial power thereby reducing power losses. In addition, since soft switching is used for switching the semiconductor switches of the power converter, switching losses are reduced. Accordingly, low voltage semiconductor switches may be employed in the power converter. Furthermore, the resonant LLC power converter is employed to process the partial power provided from the power source, thereby providing improved efficiency of the power converter. The various embodiments of the partial power processing power converter with soft switching may find application in solar, battery, fuel cells, and other renewable and non-renewable power generation systems.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

1. A power conversion system, comprising:
a power source;
a power converter operatively coupled to the power source;
a controller configured to:
determine a value of at least one parameter corresponding to the power source;
provide a first portion of the at least one parameter to the power converter;
modify an operating frequency of the power converter, duty ratio of the power converter, or a combination thereof;
obtain an electrical quantity at an output of the power converter based on the modified operating frequency, the modified duty ratio, or a combination thereof; and
deliver a combination of the electrical quantity obtained at the output of the power converter and a second portion of the at least one parameter to a load.

2. The system of claim 1, wherein the power source comprises a photovoltaic panel, a fuel cell, a battery, or combinations thereof.

3. The system of claim 1, wherein the power converter comprises at least one phase leg having at least two semiconductor switches, a resonant circuit, a transformer, a rectifier, or combinations thereof.

4. The system of claim 3, wherein the resonant circuit comprises a capacitor, an inductor, or a combination thereof.

5. The system of claim 3, wherein the rectifier comprises at least two semiconductor switches.

6. The system of claim 3, wherein the transformer comprises at least one primary winding, at least one secondary winding, or a combination thereof.

7. The system of claim 3, wherein the at least two semiconductor switches comprise an insulated gate bipolar transistor, a metal oxide semiconductor field effect transistor, a field effect transistor, an injection enhanced gate transistor, an integrated gate commutated thyristor, a diode, or combinations thereof.

8. The system of claim 3, wherein the at least two semiconductor switches comprise a gallium arsenide based switch, a gallium nitride based switch, a silicon carbide based switch, or combinations thereof.

9. The system of claim 3, wherein the controller is further configured to selectively switch the at least two semiconductor switches of the power converter.

10. The system of claim 9, wherein the controller is configured to cause a switch current to flow through the at least two semiconductor switches of the power converter when a value of voltage across the at least two semiconductor switches is zero.

11. The system of claim 1, wherein the controller is configured to regulate the value of the at least one parameter corresponding to the power source to obtain a maximum power output from the power source.

12. The system of claim 1, wherein the at least one parameter corresponding to the power source comprises a voltage, a current, or a combination thereof, and wherein the electrical quantity obtained at the output of the power converter comprises a voltage, a current, or a combination thereof.

13. The system of claim 1, wherein the load comprises a direct current link capacitor, a direct current to alternating current converter, a grid, or combinations thereof.

14. The system of claim 1, wherein the power converter comprises a LLC resonant converter.

15. A method for converting power, comprising:
coupling a power source to a power converter and a load;
determining a value of at least one parameter corresponding to the power source;
providing a first portion of the at least one parameter to the power converter;
modifying an operating frequency of the power converter, a duty ratio of the power converter, or a combination thereof;
obtaining an electrical quantity at an output of the power converter based on the modified operating frequency, the modified duty ratio, or a combination thereof; and
delivering a combination of the electrical quantity obtained at the output of the power converter and a second portion of the at least one parameter to the load.

16. The method of claim 15, further comprising selectively switching at least two semiconductor switches of the power converter.

17. The method of claim 16, wherein selectively switching the at least two semiconductor switches of the power converter comprises at least one of activating or deactivating the at least two semiconductor switches.

18. The method of claim 16, wherein selectively switching the at least two semiconductor switches of the power converter comprises causing a switch current to flow through the at least two semiconductor switches when a voltage across the at least two semiconductor switches is zero.

19. The method of claim 15, further comprising regulating the value of the at least one parameter corresponding to the power source to obtain a maximum power output from the power source.

20. The method of claim 15, wherein the at least one parameter corresponding to the power source comprises a voltage, a current, or a combination thereof, and wherein the electrical quantity obtained at the output of the power converter comprises a voltage, a current, or a combination thereof.
